(19) United States
(12) Patent Application Publication
(10) Pub. No.: US 2025/0181640 A1
(43) Pub. Date: Jun. 5, 2025

(54) SEARCH RESULT DISPLAY METHOD, COMPUTER DEVICE, AND STORAGE MEDIUM

(71) Applicant: Douyin Vision (Beijing) Co., Ltd., Beijing (CN)

(72) Inventors: Yating LIN, Beijing (CN); Yanli WANG, Beijing (CN); Guohua YANG, Beijing (CN); Chao QIAO, Beijing (CN); Cheng LV, Beijing (CN); Dongjin HUANG, Beijing (CN); Tongjun LI, Beijing (CN); Yuquan GAO, Beijing (CN); Binger SHEN, Beijing (CN)

(21) Appl. No.: 18/839,975

(22) PCT Filed: May 17, 2023
(86) PCT No.: PCT/CN2023/094760

§ 371 Date: Aug. 20, 2024

(30) Foreign Application Priority Data
Jun. 24, 2022 (CN) 202210723399.0

(51) Int. Cl. G06F 16/738; G06F 16/78

(52) U.S. Cl. CPC G06F 16/738; G06F 16/7867

(57) ABSTRACT

A search result display method and apparatus, a computer device, and a storage medium are provided. The method includes: obtaining, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video; and displaying the video preview information on a search result page, and displaying the structured information at an associated position of the video preview information.

The present application claims priority to Chinese Patent Application No. 202210723399.0, filed on Jun. 24, 2022, which is incorporated herein by reference in its entirety as a part of the present application.

### TECHNICAL FIELD

Embodiments of the present disclosure relate to a search result display method and apparatus, a computer device, and a storage medium.

### BACKGROUND

In a search scenario, after a search is performed using search information, a search result that includes a video can be obtained.

For such a video-type search result, the complete video usually needs to be viewed before desired information can be obtained, such that information related to a search need cannot be quickly obtained from the video.

### SUMMARY

Embodiments of the present disclosure provide at least a search result display method and apparatus, a computer device, and a storage medium.

According to a first aspect, an embodiment of the present disclosure provides a search result display method, including: obtaining, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video; and displaying the video preview information on a search result page, and displaying the structured information at an associated position of the video preview information.

In an optional implementation, the displaying the video preview information on a search result page, and displaying the structured information at an associated position of the video preview information includes: displaying the video preview information in a first area of the search result page, successively displaying the timestamp information in a second area adjacent to the first area, and displaying, at a corresponding position of each piece of timestamp information, prerequisite information and answer information corresponding to the timestamp information.

In an optional implementation, at least one piece of prerequisite information is included, and each piece of prerequisite information corresponds to at least one piece of answer information; and the displaying the video preview information on a search result page, and displaying the structured information at an associated position of the video preview information includes: displaying the video preview information in the first area of the search result page, successively displaying, in the second area adjacent to the first area, each piece of prerequisite information and timestamp information corresponding to the piece of prerequisite information in the structured information, and displaying, under each piece of prerequisite information, at least one piece of corresponding answer information and timestamp information corresponding to each piece of answer information.

In an optional implementation, the displaying the video preview information on a search result page, and displaying the structured information at an associated position of the video preview information includes: when the structured information includes one piece of prerequisite information and a plurality of pieces of answer information, displaying the video preview information in the first area of the search result page, displaying, in the second area adjacent to the first area, the prerequisite information and timestamp information corresponding to the prerequisite information, and successively displaying, under the prerequisite information, the plurality of pieces of answer information and timestamp information respectively corresponding to the pieces of answer information in a sequence of timestamps corresponding to the plurality of pieces of answer information; or when the structured information includes a plurality of pieces of prerequisite information and each piece of prerequisite information corresponds to a plurality of pieces of answer information, displaying the video preview information in the first area of the search result page, successively displaying, in the second area adjacent to the first area, the pieces of prerequisite information and timestamp information corresponding to the pieces of prerequisite information in a sequence of timestamps of the pieces of prerequisite information, and successively displaying, under each piece of prerequisite information, pieces of answer information corresponding to the piece of prerequisite information and timestamp information respectively corresponding to the pieces of answer information in a sequence of timestamps of the pieces of answer information.

In an optional implementation, the displaying the structured information at an associated position of the video preview information includes: determining, based on an answer type of answer information corresponding to each piece of prerequisite information, a display form of each piece of prerequisite information and the corresponding answer information; and displaying each piece of prerequisite information and the corresponding answer information at the associated position of the video preview information based on the display form.

In an optional implementation, the answer type of the answer information corresponding to each piece of prerequisite information is determined in the following manner: if the target video includes a plurality of pieces of step information corresponding to the search request, determining that the answer type is a first answer type, where each piece of answer information corresponds to one piece of step information; or if the target video includes a plurality of parts of answer information corresponding to the search request, and each part of answer information includes a plurality of parts of sub-answer information, determining that the answer type is a second answer type.

In an optional implementation, in response to the answer type being the first answer type, the displaying each piece of prerequisite information and the corresponding answer information at the associated position of the video preview information based on the display form includes: displaying, at the associated position of the video preview information, timestamp information of the prerequisite information and each part of answer information in a sequence of timestamps corresponding to the prerequisite information and the corresponding answer information.

In an optional implementation, in response to the answer type corresponding to the answer information being the second answer type, the displaying each piece of prerequisite information and the corresponding answer information at the associated position of the video preview information based on the display form includes: displaying each part of answer information at the associated position of the video preview information; and displaying, in response to a trigger operation for any piece of answer information, a plurality of pieces of sub-answer information corresponding to the answer information.

In an optional implementation, the structured information further includes recommendation information associated with the search request; and the displaying the structured information at an associated position of the video preview information includes: displaying, at a corresponding position of each piece of timestamp information, prerequisite information and answer information corresponding to the timestamp information, and displaying, under at least one piece of answer information, the recommendation information associated with the search request and the answer information.

In an optional implementation, the method further includes: playing, in response to a trigger operation for the prerequisite information or any part of answer information in the structured information, the target video from a timestamp position corresponding to the prerequisite information or the part of answer information.

In an optional implementation, in response to a plurality of target videos being included, the method further includes: determining degrees of association between structured information of the plurality of target videos and the search request, and sorting the plurality of target videos based on the degrees of association; and the displaying the video preview information, and displaying the structured information at an associated position of the video preview information includes: successively displaying video preview information of the plurality of target videos based on a result of sorting the target videos, and displaying the structured information at associated positions of the video preview information.

According to a second aspect, an embodiment of the present disclosure further provides a search result display apparatus, including: an obtaining module configured to obtain, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video; and a display module configured to display the video preview information on a search result page, and display the structured information at an associated position of the video preview information.

In an optional implementation, when displaying the video preview information on the search result page, and displaying the structured information at the associated position of the video preview information, the display module is configured to: display the video preview information in a first area of the search result page, successively display the timestamp information in a second area adjacent to the first area, and display, at a corresponding position of each piece of timestamp information, prerequisite information and answer information corresponding to the timestamp information.

In an optional implementation, at least one piece of prerequisite information is included, and each piece of prerequisite information corresponds to at least one piece of answer information; and when displaying the video preview information on the search result page, and displaying the structured information at the associated position of the video preview information, the display module is configured to: display the video preview information in the first area of the search result page, successively display, in the second area adjacent to the first area, each piece of prerequisite information and timestamp information corresponding to the piece of prerequisite information in the structured information, and display, under each piece of prerequisite information, at least one piece of corresponding answer information and timestamp information corresponding to each piece of answer information.

In an optional implementation, when displaying the video preview information on the search result page, and displaying the structured information at the associated position of the video preview information, the display module is configured to: when the structured information includes one piece of prerequisite information and a plurality of pieces of answer information, display the video preview information in the first area of the search result page, display, in the second area adjacent to the first area, the prerequisite information and timestamp information corresponding to the prerequisite information, and successively display, under the prerequisite information, the plurality of pieces of answer information and timestamp information respectively corresponding to the pieces of answer information in a sequence of timestamps corresponding to the plurality of pieces of answer information; or when the structured information includes a plurality of pieces of prerequisite information and each piece of prerequisite information corresponds to a plurality of pieces of answer information, display the video preview information in the first area of the search result page, successively display, in the second area adjacent to the first area, the pieces of prerequisite information and timestamp information corresponding to the pieces of prerequisite information in a sequence of timestamps of the pieces of prerequisite information, and successively display, under each piece of prerequisite information, pieces of answer information corresponding to the piece of prerequisite information and timestamp information respectively corresponding to the pieces of answer information in a sequence of timestamps of the pieces of answer information.

In an optional implementation, when displaying the structured information at the associated position of the video preview information, the display module is configured to: determine, based on an answer type of answer information corresponding to each piece of prerequisite information, a display form of each piece of prerequisite information and the corresponding answer information; and display each piece of prerequisite information and the corresponding answer information at the associated position of the video preview information based on the display form.

In an optional implementation, the answer type of the answer information corresponding to each piece of prerequisite information is determined in the following manner: if the target video includes a plurality of pieces of step information corresponding to the search request, determining that the answer type is a first answer type, where each part of answer information corresponds to one piece of step information; or if the target video includes a plurality of parts of answer information corresponding to the search request, and each part of answer information includes a plurality of parts of sub-answer information, determining that the answer type is a second answer type.

In an optional implementation, in response to the answer type being the first answer type, when displaying each piece of prerequisite information and the corresponding answer information at the associated position of the video preview information based on the display form, the display module is configured to: display, at the associated position of the video preview information, timestamp information of the prerequisite information and each part of answer information in a sequence of timestamps corresponding to the prerequisite information and the corresponding answer information.

In an optional implementation, in response to the answer type corresponding to the answer information being the second answer type, when displaying each piece of prerequisite information and the corresponding answer information at the associated position of the video preview information based on the display form, the display module is configured to: display each part of answer information at the associated position of the video preview information; and display, in response to a trigger operation for any piece of answer information, a plurality of pieces of sub-answer information corresponding to the answer information.

In an optional implementation, the structured information further includes recommendation information associated with the search request; and when displaying, at a corresponding position of each piece of timestamp information, prerequisite information and answer information corresponding to the timestamp information, the display module is configured to: display, at a corresponding position of each piece of timestamp information, prerequisite information and answer information corresponding to the timestamp information, and display, under at least one piece of answer information, the recommendation information associated with the search request and the answer information.

In an optional implementation, the search result display apparatus further includes a first processing module configured to: play, in response to a trigger operation for the prerequisite information or any part of answer information in the structured information, the target video from a timestamp position corresponding to the prerequisite information or the part of answer information.

In an optional implementation, in response to a plurality of target videos being included, the search result display apparatus further includes a second processing module configured to: determine degrees of association between structured information of the plurality of target videos and the search request, and sort the plurality of target videos based on the degrees of association; and when displaying the video preview information, and displaying the structured information at the associated position of the video preview information, the display module is configured to: successively display video preview information of the plurality of target videos based on a result of sorting the target videos, and display the structured information at associated positions of the video preview information.

According to a third aspect, an optional implementation of the present disclosure further provides a computer device including a processor and a memory, where the memory stores machine-readable instructions executable by the processor, the processor is configured to execute the machine-readable instructions stored in the memory, and the machine-readable instructions, when executed by the processor, cause the steps in the first aspect described above or any one of possible implementations of the first aspect to be performed.

According to a fourth aspect, an optional implementation of the present disclosure further provides a computer-readable storage medium having stored thereon a computer program that, when run, causes the steps in the first aspect described above or any one of possible implementations of the first aspect to be performed.

For descriptions of effects of the above search result display apparatus, computer device, and computer-readable storage medium, reference is made to the descriptions of the above search result display method, and details are not described herein again.

According to the search result display method and apparatus, the computer device, and the storage medium provided in embodiments of the present disclosure, for a target video found, structured information for answering a search request is obtained through information extraction, and video preview information and structured information of the target video are displayed. The structured information includes answer information, prerequisite information corresponding to the answer information, and timestamp information that respectively corresponds to the prerequisite information and the answer information in the target video. In this way, a user can intuitively learn, by using the structured information, playback positions of a related prerequisite and a related answer that are needed by the user in the video, and then locate the specific playback positions to view related video details. Therefore, according to the search result display method provided in embodiments of the present disclosure, valid information can be quickly obtained more conveniently.

In order to make the above objectives, features, and advantages of the present disclosure more obvious and comprehensible, a detailed description will be provided below with reference to the preferred embodiments and in conjunction with the accompanying drawings.

### BRIEF DESCRIPTION OF DRAWINGS

In order to more clearly illustrate the technical solutions in the embodiments of the present disclosure, the accompanying drawings for describing the embodiments will be briefly described below. The accompanying drawings herein, which are incorporated into and form a part of the specification, show the embodiments in line with the present disclosure and are used in conjunction with the description to illustrate the technical solutions of the present disclosure. It should be understood that the following accompanying drawings only show some embodiments of the present disclosure, and therefore should not be considered as a limitation on the scope. For those of ordinary skill in the art, other related accompanying drawings can be derived from these accompanying drawings without creative efforts.

FIG. 1 is a flowchart of a search result display method according to an embodiment of the present disclosure;

FIG. 2 is a schematic diagram of a search result page according to an embodiment of the present disclosure;

FIG. 3 is a schematic diagram of a search result page displayed when only one piece of prerequisite information is included according to an embodiment of the present disclosure;

FIG. 4 is a schematic diagram of a search result page displayed when a plurality of pieces of prerequisite information are included according to an embodiment of the present disclosure;

FIG. 5 is a schematic diagram of a search result page displayed when an answer type of answer information is a second answer type according to an embodiment of the present disclosure;

FIG. 6 is a schematic diagram of a search result page displayed when sub-answer information is displayed according to an embodiment of the present disclosure;

FIG. 7 is a schematic diagram of a search result page displayed after answer information is triggered according to an embodiment of the present disclosure;

FIG. 8 is a schematic diagram of a search result display apparatus according to an embodiment of the present disclosure; and

FIG. 9 is a schematic diagram of a computer device according to an embodiment of the present disclosure.

### DETAILED DESCRIPTION

In order to make the objectives, technical solutions, and advantages of embodiments of the present disclosure clearer, the technical solutions in the embodiments of the present disclosure will be clearly and comprehensively described below with reference to the accompanying drawings in the embodiments of the present disclosure. Clearly, the described embodiments are merely some rather than all of the embodiments of the present disclosure. In general, the components of the embodiments of the present disclosure described and shown herein can be arranged and designed in various configurations. Therefore, the following detailed description of the embodiments of the present disclosure is not intended to limit the scope of protection of the present disclosure, but merely represents selected embodiments of the present disclosure. All other embodiments obtained by those skilled in the art based on the embodiments of the present disclosure without creative efforts shall fall within the scope of protection of the present disclosure.

It is found through research that, in a scenario in which a search is performed using search information, content information related to the search information is usually included in a video that can be found. In a possible case, the related content information may be text information uploaded by a user, rather than extracted from the video. In this case, it is difficult for the user to determine a related playback position from the video based on the displayed text information and then quickly locate the specific playback position to view video details.

Based on the above research, the present disclosure provides a search result display method. For a target video found, structured information for answering a search request is obtained through information extraction, and video preview information and the structured information of the target video are displayed. The structured information includes answer information, prerequisite information corresponding to the answer information, and timestamp information that respectively corresponds to the prerequisite information and the answer information in the target video. In this way, a user can intuitively learn, by using the structured information, playback positions of a related prerequisite and a related answer that are needed by the user in the video, and then locate the specific playback positions to view related video details. Therefore, according to the search result display method provided in embodiments of the present disclosure, valid information can be quickly obtained more conveniently.

The defects that exist in the above solution are all obtained by the inventors through practice and careful research. Therefore, the process of discovering the above problem, and the solutions to the above problem that are provided in the present disclosure hereinafter should all be contributions made by the inventors to the present disclosure in the course of the present disclosure.

It should be noted that similar reference signs and letters refer to similar items in the following accompanying drawings. Therefore, once a specific item is defined in one of the accompanying drawings, it need not be further defined and explained in subsequent accompanying drawings.

To facilitate understanding of the embodiments, a search result display method disclosed in the embodiments of the present disclosure is first described in detail. The search result display method provided in the embodiments of the present disclosure is usually performed by a computer device that has a specific computing capability. For example, the computer device includes: a terminal device, a server, or another processing device. The terminal device may be user equipment (UE), a mobile device, a user terminal, a terminal, a cellular phone, a cordless phone, a personal digital assistant (PDA), a handheld device, a computing device, an in-vehicle device, a wearable device, or the like. In some possible implementations, the search result display method may be implemented by a processor by invoking computer-readable instructions stored in a memory.

The search result display method provided in the embodiments of the present disclosure is described below by using an example in which an execution body is a client.

FIG. 1 is a flowchart of a search result display method according to an embodiment of the present disclosure. The method includes step S101 and S102.

S101: Obtain, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video.

S102: Display the video preview information on a search result page, and display the structured information at an associated position of the video preview information.

S101 and S102 are described below in detail.

For S101, when performing a search, a user enters search information in a search box and triggers a search operation button, such that the client can send the search request. The search request includes the search information, where the search information includes a search field, a question, and the like that are entered by the user. After receiving the search request, a server may determine, based on the search information in the search request, a target video that matches the search information from a plurality of available videos. The target video that matches the search information herein specifically includes a video, selected from the plurality of videos, with at least one of a video frame, a voice, text content, and the like being capable of serving as answer information for a question. The target video may be determined from the plurality of videos through online processing by using the search information.

The target video further corresponds to a preview resource. The preview resource includes video preview information mainly displayed as an image and structured information, mainly displayed as text, for answering the search request. The preview resource of the target video may be performed through online processing. For example, after the target video is determined based on the search request, the target video is processed to obtain the preview resource. Alternatively, a corresponding preview resource may be determined for the video after the video is uploaded, such that the preview resource corresponding to the video may be directly displayed when the video is displayed to the user as the target video.

The video preview information may be any video frame in the target video, for example, a first video frame, or may be determined in response to an operation of selecting a plurality of video frames of the target video by the user. Alternatively, another video frame image or the like uploaded by the user may be used as the video preview information, which is not limited herein.

The structured information is specifically extracted from the target video. For example, the target video may be processed through optical character recognition (OCR), automatic speech recognition (ASR), or the like, to obtain text information included in the target video. An operation such as semantic recognition may be performed on the text information to classify the obtained text information into different parts such as prerequisite information, answer information, concept definition information, and precaution information based on the search request. For the search request, the obtained target video primarily includes the prerequisite information and the answer information. Therefore, the following mainly describes these two parts of information. The concept definition information and the precaution information that may exist may be displayed in a display manner similar to that of the answer information.

Herein, because the prerequisite information and the answer information are specifically extracted from the target video, positions in the target video at which the prerequisite information and the answer information are extracted may be further obtained, which, for example, specifically include timestamp information that respectively corresponds to the prerequisite information and the answer information in the target video.

For a specific manner of obtaining the preview resource of the target video that matches the search request, a possible example is provided as a reference. For example, if a question corresponding to the search request is “Heimlich maneuver”, after the target video that matches the search request is obtained, the preview resource of the target video may be determined. The preview resource includes a first frame of video frame image of the target video. For the extracted text information, it is determined that prerequisite information and corresponding timestamp information in the target video include “For an adult patient who has just inhaled a foreign object”—“00:02”; it is determined that answer information and corresponding timestamp information in the target video respectively include “Stand behind the patient, place one foot between the patient's legs, and wrap your arms around the patient”—“00:14”, “Make a first with your left hand and grab your left wrist from the front with your right hand”—“00:26”, and “Suddenly tighten both arms, and press fiercely the left first knuckle against the patient's upper abdomen, forcing the upper abdomen to sink inward”—“00:32”.

In this way, after the matched target video is determined using the search request, each part of content included in the preview resource of the target video may be determined, and the preview resource may continue to be displayed.

In a possible case, if a plurality of matched target videos may be determined for the search request, the plurality of obtained target videos may be arranged for display, or one of the plurality of obtained target videos may be selected for display.

The plurality of target videos may be arranged based on degrees of association between structured information of the target videos and the search request. Specifically, degrees of association between the structured information of the plurality of target videos and the search request may be determined, the plurality of target videos are sorted based on the degrees of association, and then preview information of the plurality of target videos is successively displayed based on a result of sorting the target videos. For example, the degree of association may be determined by using a semantic similarity between the structured information and the search information corresponding to the search request. For example, the semantic similarity between the structured information and the search information is directly used as the degree of association. When the degree of association is determined, a target video to which structured information with a higher degree of association with the search information belongs may be arranged at a front position, and a target video to which structured information with a lower degree of association belongs may be arranged at a rear position. Then, the preview information of the target videos is successively displayed based on the sorting result obtained through arrangement.

When one target video is selected from the plurality of target videos for display, the plurality of target videos may also be sorted in the above manner, and a target video to which structured information with a highest degree of association with the search request belongs is selected from the plurality of target videos for display.

Herein, when there are the plurality of target videos, any manner may be selected based on actual needs to display the plurality of target videos. For example, a button for switching a display state may be provided, and a display form is determined in response to the user's trigger operation on the button for the display state. Alternatively, in response to a network environment of a device, for example, when information is obtained and displayed using data traffic, to reduce an amount of data to be transmitted, only one target video may be selected for display. However, when information is obtained and displayed using a broadband network, the plurality of target videos may be sorted and displayed, to display more information.

For S102, after the preview information of the target video that matches the search request is determined based on the above steps, the video preview information in the preview information may be displayed on the search result page, and the structured information may be displayed at the associated position of the video preview information.

In a specific implementation, when the video preview information is displayed and the structured information is displayed in an associated manner, the following manner may be specifically used: displaying the video preview information in a first area of the search result page, successively displaying the timestamp information in a second area adjacent to the first area, and displaying, at a corresponding position of each piece of timestamp information, prerequisite information and answer information corresponding to the timestamp information.

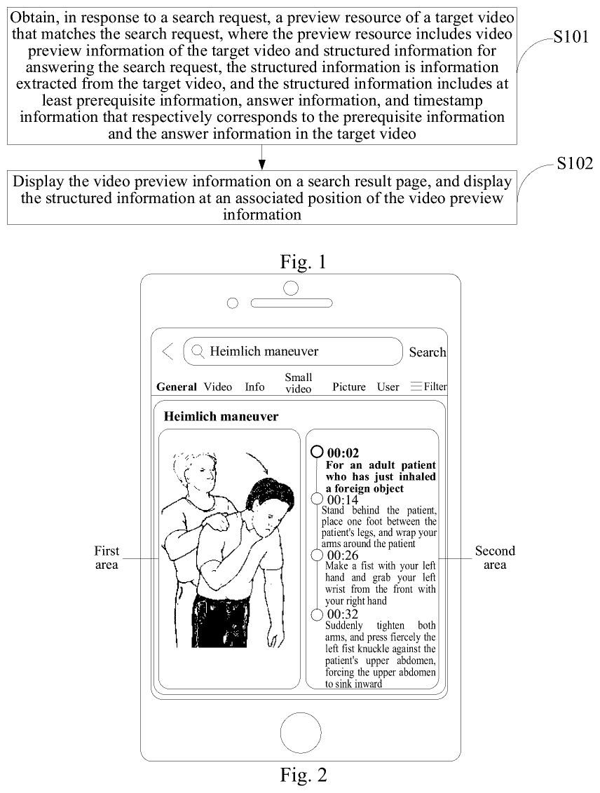

Different from a search page on which the user enters a question, the search result page is used to display the obtained preview resource of the target video to the user. For example, FIG. 2 is a schematic diagram of a search result page according to an embodiment of the present disclosure. The search result page includes a first area and a second area, and the first area is adjacent to the second area. Herein, the first area and the second area are displayed horizontally adjacent to each other on the search result page, such that the video preview information in the first area may be displayed together with the structured information. The user does not need to repeatedly drag up and down to view two different types of information. Therefore, fewer operation actions are needed, which is more convenient for the user to view and obtain the information.

In the example provided in step S101, the first area displays the video preview information of the target video, and the second area displays the timestamp information, and corresponding prerequisite information and answer information are displayed under each timestamp. Herein, the timestamp information is displayed in a time sequence corresponding to the timestamp information, for example, displayed in the form of a timeline, such that displayed information further has coherence in time. Because the timestamp information corresponds to the prerequisite information and the answer information, the prerequisite information and the answer information may be displayed at a corresponding position of the displayed timestamp information.

In a possible case, if the target video is not played, a first piece of displayed structured information and corresponding timestamp information may be displayed in bold, to prompt the user of nearest information to be displayed in the target video. In addition, the search result page may further display title information of the target video. For example, the title “Heimlich maneuver” is shown in bold above the first area.

In addition, in the displayed structured information, there is a correspondence between the prerequisite information and the answer information. Specifically, at least one piece of prerequisite information is included, and each prerequisite may have at least one piece of corresponding answer information. Therefore, when the video preview information is displayed on the search result page and the structured information is displayed at the associated position of the video preview information, the video preview information may be displayed in the first area of the search result page, each piece of prerequisite information and timestamp information corresponding to the piece of prerequisite information in the structured information may be successively displayed in the second area adjacent to the first area, and at least one piece of corresponding answer information and timestamp information corresponding to each piece of answer information may be displayed under the piece of prerequisite information.

The following describes different cases in which one or more pieces of prerequisite information are included.

First, when one piece of prerequisite information is included, the prerequisite information may correspond to a plurality of pieces of answer information. In this case, the video preview information may be displayed in the first area of the search result page, the prerequisite information and timestamp information corresponding to the prerequisite information may be displayed in the second area adjacent to the first area, and the plurality of pieces of answer information and timestamp information corresponding to each piece of answer information may be successively displayed under the prerequisite information in a sequence of timestamps corresponding to the plurality of pieces of answer information.

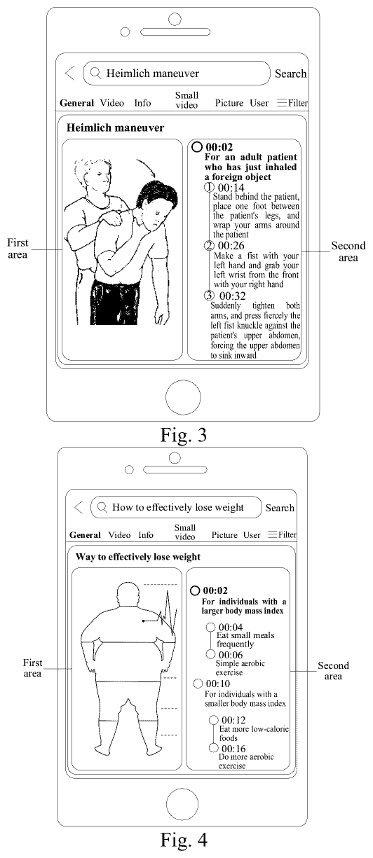

For example, FIG. 3 is a schematic diagram of a search result page displayed when only one piece of prerequisite information is included according to an embodiment of the present disclosure. Corresponding to FIG. 2, only one piece of prerequisite information is included, but the answer information is a plurality of steps, and therefore there are a plurality of pieces of answer information. In the figure, a sequence of steps is marked using reference numerals. To more intuitively display a correspondence between the prerequisite information and the answer information, compared with FIG. 2, in FIG. 3, the prerequisite information and the answer information are displayed in a form similar to a multi-level title. Specifically, the prerequisite information is used as an upper-level title, and the corresponding answer information is used as a lower-level title, to be staggered from the upper-level title for display.

Then, when a plurality of pieces of prerequisite information are included, each piece of prerequisite information may also correspond to a plurality of pieces of answer information. In this case, the video preview information may be displayed in the first area of the search result page, the pieces of the prerequisite information and timestamp information corresponding to the pieces of the prerequisite information may be successively displayed in the second area adjacent to the first area in a sequence of timestamps of the pieces of prerequisite information, and under each piece of prerequisite information, pieces of answer information corresponding to the prerequisite information and timestamp information corresponding to the pieces of the answer information may be successively displayed in a sequence of timestamps of the pieces of answer information.

For example, if the question corresponding to the search request is “How to effectively lose weight”, the obtained structured information determined in the target video includes, for example, two prerequisites and two pieces of answer information corresponding to each prerequisite. A first piece of prerequisite information is, for example, “For individuals with a larger body mass index”, corresponding timestamp information is “00:02”, and two pieces of corresponding answer information are, for example, “Eat small meals frequently” and “Simple aerobic exercise”, which respectively correspond to timestamp information “00:04” and “00:06”. A second piece of prerequisite information is, for example, “For individuals with a smaller body mass index”, corresponding timestamp information is “00:10”, and two pieces of corresponding answer information are, for example, “Eat more low-calorie foods” and “Do more aerobic exercise”, which respectively correspond to timestamp information “00:12” and “00:16”.

Correspondingly, FIG. 4 is a schematic diagram of a search result page displayed when a plurality of pieces of prerequisite information are included according to an embodiment of the present disclosure. Compared with FIG. 3, because there are a plurality of pieces of prerequisite information, each piece of prerequisite information and a plurality of pieces of answer information corresponding to the piece of prerequisite information are displayed by using a multi-level title. In this way, display is performed in a hierarchical manner, such that displayed information can be more logical, and logical confusion can be avoided when prerequisite information and answer information are in a many-to-many correspondence. Therefore, it can be easier for the user to find and display a plurality of pieces of prerequisite information, and it is easier for the user to obtain a plurality of pieces of corresponding answer information from each prerequisite.

In addition, when the structured information is displayed at the associated position of the video preview information, in addition to using the correspondence between the prerequisite information and the answer information for display, a display form of each piece of prerequisite information and corresponding answer information may be determined based on an answer type of the answer information corresponding to the piece of prerequisite information, to display each piece of prerequisite information and the corresponding answer information at the associated position of the video preview information based on the display form.

In a specific implementation, the answer type of the answer information corresponding to each piece of prerequisite information may be specifically determined in the following manner: if the answer information includes a plurality of pieces of step information corresponding to the search request, determining that the answer type is a first answer type, that is, a step answer type, where each part of answer information corresponds to one piece of step information; or if the answer information includes a plurality of parts of answer information corresponding to the search request, and each part of answer information includes a plurality of parts of sub-answer information, determining that the answer type is a second answer type, that is, a multi-level answer type.

For example, for the above-described case in which the question corresponding to the search request is “Heimlich maneuver”, obtaining the plurality of pieces of answer information by using the target video includes a plurality of consecutive steps. Therefore, each piece of answer information may be used as a plurality of pieces of step information corresponding to the search request. In this case, it may be determined that the answer information is the first answer type. Correspondingly, it may be determined that the prerequisite information and the answer information of the first answer type are displayed in a single-level display form.

In a specific implementation, when the answer type of the answer information is the first answer type, each piece of prerequisite information and the corresponding answer information may be displayed at the associated position of the video preview information based on the display form in the following manner: displaying, at the associated position of the video preview information, timestamp information of the prerequisite information and each part of answer information in a sequence of timestamps corresponding to the prerequisite information and the corresponding answer information.

Herein, for the manner of displaying the structured information corresponding to the target video “Heimlich maneuver”, display may be performed in any manner in FIG. 2 or FIG. 3 because the single-level display form is used for display. In other words, cases of displaying the answer information in FIG. 2 and FIG. 3 are cases of single-level display.

In addition, the structured information may alternatively include a plurality of parts of answer information, and each part of answer information further includes a plurality of parts of sub-answer information. For example, for a question “What is suitable for eating in a day” corresponding to the search request, the structured information obtained after the target video is determined includes, for example, two pieces of different prerequisite information, including “What to eat for a child” and “What to eat for an adult”, which respectively correspond to timestamps “00:00” and “01:00”. For example, the prerequisite information “What to eat for a child” first may correspond to four parts of answer information, including “Breakfast”, “Lunch”, “Extra meal”, and “Dinner”, which respectively correspond to timestamps “00:02”, “00:12”, “00:22”, and “00:32”. The part of answer information “Breakfast” further includes two pieces of sub-answer information, for example, “Whole grain bread” and “Oat milk”, which respectively correspond to timestamps “00:04” and “00:08”. However, the part of answer information “Lunch” may also include two pieces of sub-answer information, for example, “Stir-fried vegetables” and “Tomato and egg noodles”, which respectively correspond to timestamps “00:14” and “00:18”. In this case, it may be determined that the answer information is the second answer type. Correspondingly, it may be determined that the prerequisite information and an answer of the second answer type are displayed in a multi-level display form.

In a specific implementation, when the answer type of the answer information is the second answer type, each piece of prerequisite information and the corresponding answer information may be displayed at the associated position of the video preview information based on the display form in the following manner: displaying each part of answer information at the associated position of the video preview information; and displaying, in response to a trigger operation for any piece of answer information, a plurality of pieces of sub-answer information corresponding to the answer information.

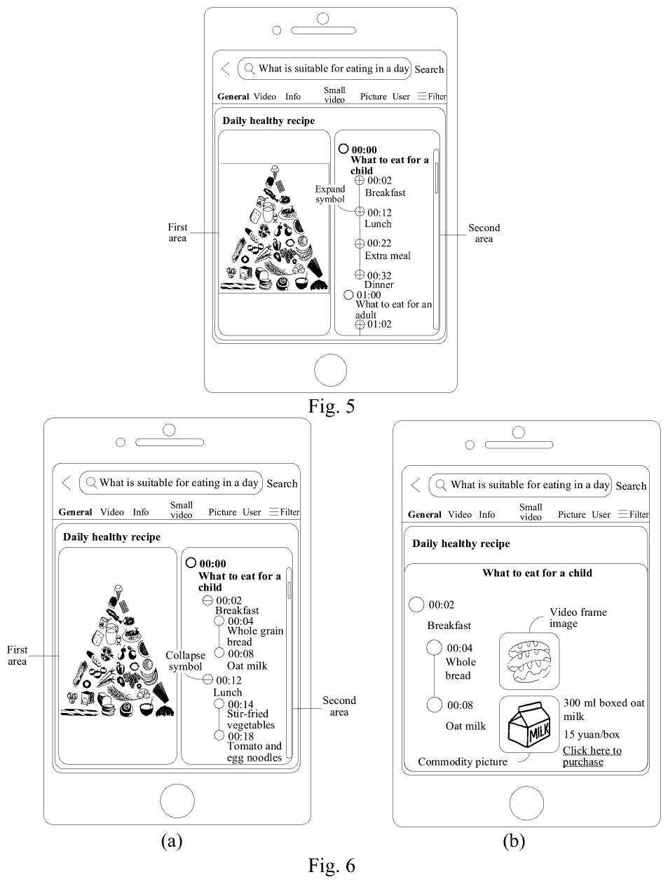

For example, FIG. 5 is a schematic diagram of a search result page displayed when an answer type of answer information is a second answer type according to an embodiment of the present disclosure. For the second area in the search result page, after each piece of prerequisite information and corresponding timestamp information are displayed, parts of answer information may be first displayed in an associated manner under each piece of prerequisite information. For example, four pieces of corresponding answer information, namely, “Breakfast”, “Lunch”, “Extra meal”, and “Dinner”, are displayed under the prerequisite information “What to eat for a child”. An answer level of the answer information further includes another answer level, and displayed information is redundant if the answer information and sub-answer information at the two answer levels are displayed together. Therefore, answer information having sub-answer information at a next answer level may be identified using an expand symbol.

For collapsed answer information under which sub-answer information is not directly displayed, sub-answer information under any piece of answer information may be displayed in response to a trigger operation on the answer information. Specifically, the sub-answer information may be displayed on the search result page that displays the answer information, or may be displayed in a new pop-up window.

For example, FIG. 6 is a schematic diagram of a search result page displayed when sub-answer information is displayed according to an embodiment of the present disclosure. (a) in FIG. 6 is a schematic diagram obtained when sub-answer information is expanded and displayed on a same search result display page as that in FIG. 5. Compared with a display symbol in FIG. 5, an expand symbol changes to a collapse symbol for the answer information under which sub-answer information is triggered to display.

For the display manner shown in (a) in FIG. 6, sub-answer information corresponding to a plurality of pieces of answer information can be displayed on the search result page. In this manner in which no extra new page needs to be provided for display, the page is relatively tidy, and the user does not need to perform repeated operations in a plurality of interfaces. However, because display space of the second area is limited, when the sub-answer information corresponding to the plurality of pieces of answer information is displayed, only a limited amount of answer information or sub-answer information can be displayed. In addition, if a piece of answer information has a relatively large amount of sub-answer information, because other prerequisite information and answer information further need to be displayed in the second area, it may not be possible to completely display the sub-answer information corresponding to one piece of answer information.

Therefore, an embodiment of the present disclosure further provides another display manner. As shown in (b) in FIG. 6, sub-answer information corresponding to user-triggered answer information may be displayed on the search result page by using a small window page. In this way, a new small window page may be used to provide larger display space, such that sub-answer information under the answer information can be completely displayed. In addition, because the display space is relatively large, a corresponding video frame image in the target video may be further displayed during display, such that display content is more abundant. For example, the corresponding video frame image in the target video is displayed at an associated position of one piece of sub-answer information in (b) in FIG. 6.

In addition, for the answer information or the sub-answer information under the answer information, other related information such as commodity information may be further displayed in an associated manner. Specifically, during obtaining of the structured information in the preview resource, recommendation information associated with the search request, such as the above-described commodity information or other information, may be further obtained. For example, for a case in which a question corresponding to the search request is “What is suitable for eating in a day”, the recommendation information associated with the search request is, for example, commodity information corresponding to various foods, or a cooking skill teaching video. In this way, when prerequisite information and answer information corresponding to each piece of timestamp information are displayed at a corresponding position of the timestamp information, recommendation information associated with the search request and at least one piece of answer information may be further displayed under the answer information. For example, corresponding recommendation information is displayed at an associated position of one piece of sub-answer information shown in (b) in FIG. 6. The recommendation information includes commodity information of boxed milk corresponding to oat milk involved in the sub-answer information, specifically including a commodity picture, a commodity name, a commodity price, and a commodity purchase link of the boxed milk.

In this way, compared with a manner of directly stacking information for display, displaying answer information of different answer types in different display manners is more organized, thereby making the displayed information more logical, and making it easier for the user to obtain information from the displayed information.

In addition, for the prerequisite information or any part of answer information in the displayed structured information, in response to a trigger operation on any piece of information thereof, the target video may be played from a corresponding timestamp position. Alternatively, in response to a trigger operation on the timestamp information, the target video may be played from a position indicated by the timestamp information in the target video.

In a specific implementation, a relatively large amount of prerequisite information and answer information may be displayed, and step information or a plurality of parts of information that are used to answer the search information corresponding to the search request and that are included in the target video may be directly displayed to the user in a manner of displaying text information. Therefore, the user may only need to view, in a corresponding part of the target video, information of greater interest in the displayed prerequisite information and answer information. In this case, based on a trigger operation on the information of interest, a position corresponding to the information of interest in the target video may be played from a corresponding timestamp position, thereby avoiding a case in which the user needs to view a complete video to obtain the information of interest, and eliminating a need for the user to manually adjust a progress bar. Therefore, the information of interest may be displayed to the user more conveniently and quickly.

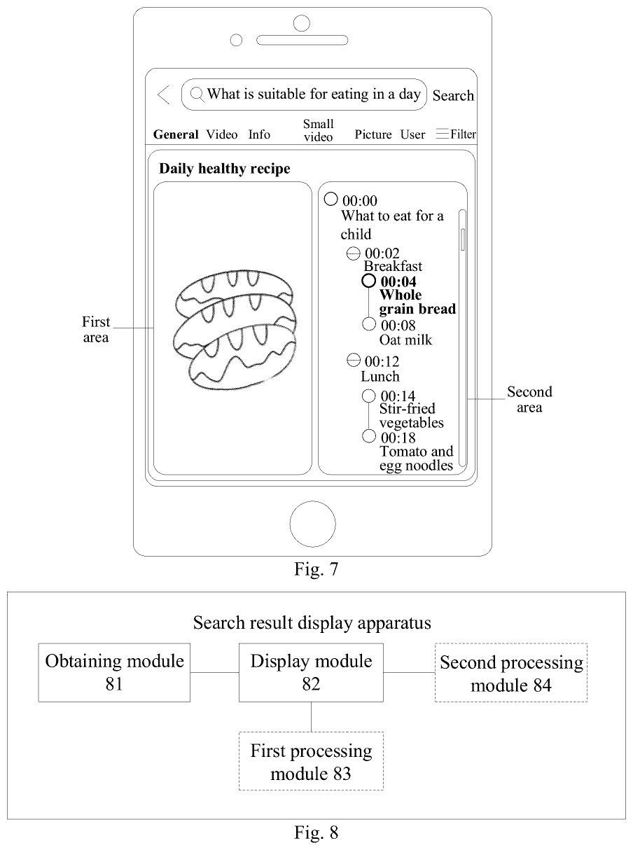

For example, FIG. 7 is a schematic diagram of a search result page displayed after answer information is triggered according to an embodiment of the present disclosure. Specifically, the sub-answer information “Whole grain bread” corresponding to the timestamp 00:04 in the second area is triggered, and correspondingly, the timestamp information and the sub-answer information are displayed in bold in the second area. In the first area, the target video jumps to a timestamp position for playback. For example, a video frame image including whole grain bread is currently being displayed.

Those skilled in the art can understand that, in the above methods of the specific implementations, the order in which the steps are written does not imply a strict execution order, and does not constitute any limitation on the implementation process. The specific execution order of the steps should be determined by their functions and possible internal logics.

Based on a same inventive concept, an embodiment of the present disclosure further provides a search result display apparatus corresponding to a search result display method. Because a principle of resolving a problem by the apparatus in this embodiment of the present disclosure is similar to the above search result display method in the embodiments of the present disclosure, for implementation of the apparatus, reference may be made to implementation of the method, and no repeated description is provided.

FIG. 8 is a schematic diagram of a search result display apparatus according to an embodiment of the present disclosure. The apparatus includes: an obtaining module 81 and a display module 82; where
the obtaining module 81 is configured to obtain, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video.
the display module 82 is configured to display the video preview information on a search result page, and display the structured information at an associated position of the video preview information.

In an optional implementation, when displaying the video preview information on the search result page and displaying the structured information at the associated position of the video preview information, the display module 82 is configured to: display the video preview information in a first area of the search result page, successively display the timestamp information in a second area adjacent to the first area, and display, at a corresponding position of each piece of timestamp information, prerequisite information and answer information corresponding to the timestamp information.

In an optional implementation, at least one piece of prerequisite information is included, and each piece of prerequisite information corresponds to at least one piece of answer information; and when displaying the video preview information on the search result page and displaying the structured information at the associated position of the video preview information, the display module 82 is configured to: display the video preview information in the first area of the search result page, successively display, in the second area adjacent to the first area, each piece of prerequisite information and timestamp information corresponding to the piece of prerequisite information in the structured information, and display, under each piece of prerequisite information, at least one piece of corresponding answer information and timestamp information corresponding to each piece of answer information.

In an optional implementation, when displaying the video preview information on the search result page and displaying the structured information at the associated position of the video preview information, the display module 82 is configured to: when the structured information includes one piece of prerequisite information and a plurality of pieces of answer information, display the video preview information in the first area of the search result page, display, in the second area adjacent to the first area, the prerequisite information and timestamp information corresponding to the prerequisite information, and successively display, under the prerequisite information, the plurality of pieces of answer information and timestamp information respectively corresponding to the pieces of answer information in a sequence of timestamps corresponding to the plurality of pieces of answer information; or when the structured information includes a plurality of pieces of prerequisite information, and each piece of prerequisite information corresponds to a plurality of pieces of answer information, display the video preview information in the first area of the search result page, successively display, in the second area adjacent to the first area, the pieces of prerequisite information and timestamp information corresponding to the pieces of prerequisite information in a sequence of timestamps of the pieces of prerequisite information, and successively display, under each piece of prerequisite information, pieces of answer information corresponding to the piece of prerequisite information and timestamp information respectively corresponding to the pieces of answer information in a sequence of timestamps of the pieces of answer information.

In an optional implementation, when displaying the structured information at the associated position of the video preview information, the display module 82 is configured to: determine, based on an answer type of answer information corresponding to each piece of prerequisite information, a display form of each piece of prerequisite information and the corresponding answer information; and display each piece of prerequisite information and the corresponding answer information at the associated position of the video preview information based on the display form.

In an optional implementation, the answer type of the answer information corresponding to each piece of prerequisite information is determined in the following manner: if the target video includes a plurality of pieces of step information corresponding to the search request, determining that the answer type is a first answer type, where each piece of answer information corresponds to one piece of step information; or if the target video includes a plurality of parts of answer information corresponding to the search request, and each part of answer information includes a plurality of parts of sub-answer information, determining that the answer type is a second answer type.

In an optional implementation, in response to the answer type being the first answer type, when displaying each piece of prerequisite information and the corresponding answer information at the associated position of the video preview information based on the display form, the display module 82 is configured to: display, at the associated position of the video preview information, timestamp information of the prerequisite information and each part of answer information in a sequence of timestamps corresponding to the prerequisite information and the corresponding answer information.

In an optional implementation, in response to the answer type corresponding to the answer information being the second answer type, when displaying each piece of prerequisite information and the corresponding answer information at the associated position of the video preview information based on the display form, the display module 82 is configured to: display each part of answer information at the associated position of the video preview information; and display, in response to a trigger operation for any piece of answer information, a plurality of pieces of sub-answer information corresponding to the answer information.

In an optional implementation, the structured information further includes recommendation information associated with the search request; and when displaying the structured information at the associated position of the video preview information, the display module 82 is configured to: display, at a corresponding position of each piece of timestamp information, prerequisite information and answer information corresponding to the timestamp information, and display, under at least one piece of answer information, the recommendation information associated with the search request and the answer information.

In an optional implementation, the search result display apparatus further includes a first processing module 83 configured to: play, in response to a trigger operation for the prerequisite information or any part of answer information in the structured information, the target video from a timestamp position corresponding to the prerequisite information or the part of answer information.

In an optional implementation, in response to a plurality of target videos being included, the search result display apparatus further includes a second processing module 84 configured to: determine degrees of association between structured information of the plurality of target videos and the search request, and sort the plurality of target videos based on the degrees of association; and when displaying the video preview information, and displaying the structured information at the associated position of the video preview information, the display module 82 is configured to: successively display video preview information of the plurality of target videos based on a result of sorting the target videos, and display the structured information at associated positions of the video preview information.

For the description of the processing processes of various modules in the apparatus, and the interaction processes between the modules, reference may be made to the related description in the above method embodiments, and details are not described herein again.

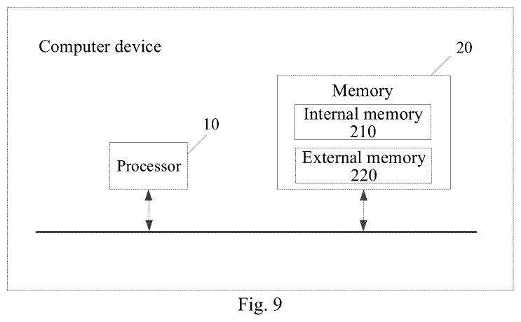

An embodiment of the present disclosure further provides a computer device. FIG. 9 is a schematic diagram of a structure of a computer device according to an embodiment of the present disclosure. The computer device includes:
a processor 10 and a memory 20. The memory 20 stores machine-readable instructions executable by the processor 10. The processor 10 is configured to execute the machine-readable instructions stored in the memory 20. When the machine-readable instructions are executed by the processor 10, the processor 10 performs the following steps:
obtaining, in response to a search request, a preview resource of a target video that matches the search request, where the preview resource includes video preview information of the target video and structured information for answering the search request, the structured information is information extracted from the target video, and the structured information includes at least prerequisite information, answer information, and timestamp information that respectively corresponds to the prerequisite information and the answer information in the target video. displaying the video preview information on a search result page, and displaying the structured information at an associated position of the video preview information.

The memory 20 includes an internal memory 210 and an external memory 220. The internal memory 210 herein is also referred to as an internal memory, and is configured to temporarily store operation data in the processor 10 and data exchanged with the external memory 220 such as a hard disk. The processor 10 exchanges data with the external memory 220 by using the internal memory 210.

For a specific execution process of the above instruction, reference may be made to search result display steps described in the embodiments of the present disclosure, and details are not described herein again.

An embodiment of the present disclosure further provides a computer-readable storage medium, where the computer-readable storage medium stores a computer program, and the computer program is run by a processor to perform search result display steps described in the above method embodiment. The storage medium may be a volatile or non-volatile computer-readable storage medium.

An embodiment of the present disclosure further provides a computer program product, where the computer program product carries program code, and instructions included in the program code may be used to perform search result display steps described in the above method embodiment. For details, reference may be made to the above method embodiment, and details are not described herein again.

The above computer program product may be implemented in the form of hardware, software or a combination thereof. In an optional embodiment, the computer program product is specifically embodied as a computer storage medium. In another optional embodiment, the computer program product is specifically embodied as a software product, such as a software development kit (SDK).

It can be clearly understood by a person skilled in the art that, for the purpose of convenient and brief description, for a detailed working process of the above system and apparatus, reference may be made to a corresponding process in the foregoing method embodiments, and details are not described herein again. In several embodiments provided in the present disclosure, it should be understood that the disclosed system, apparatus, and method may be implemented in another manner. The apparatus embodiment described above is merely an example. For example, the unit division is merely logical function division and may be other division during actual implementation. For another example, a plurality of units or components may be combined or integrated into another system, or some features may be omitted or not implemented. In addition, the displayed or discussed mutual couplings, direct couplings, or communication connections may be implemented through some communication interfaces. The indirect couplings or communication connections between the apparatuses or units may be implemented in electrical, mechanical, or other forms.

The units described as separate parts may or may not be physically separate, and parts displayed as units may or may not be physical units, and may be located at one position, or may be distributed on a plurality of network units. Some or all of the units may be selected according to actual needs to achieve the objectives of the solutions of the embodiments.

In addition, various functional units in the various embodiments of the present disclosure may be integrated into one processing unit, each of the units may exist alone physically, or two or more units may be integrated into one unit.

If the functions are implemented in the form of a software functional unit and sold or used as an independent product, the functions may be stored in a non-volatile computer-readable storage medium executable by a processor. Based on such an understanding, the technical solutions in the present disclosure essentially or a part of the technical solutions may be embodied in the form of a software product. The computer software product is stored in a storage medium, and includes several instructions for enabling a computer device (which may be a personal computer, a server, a network device, or the like) to perform all or some of the steps in the methods in the embodiments of the present disclosure. Moreover, the foregoing storage medium includes various media such as a USB flash drive, a removable hard disk, a read-only memory (ROM), a random access memory (RAM), a magnetic disk, or an optical disc that can store program code.

It should be finally noted that the embodiments described above are merely specific implementations of the present disclosure, and are used for illustrating rather than limiting the technical solutions of the present disclosure, and the scope of protection of the present disclosure is not limited thereto. Although the present disclosure has been described in detail with reference to the foregoing embodiments, those of ordinary skill in the art should understand that, within the technical scope disclosed in the present disclosure, any person skilled in the art could still modify the technical solutions specified in the foregoing embodiments, or readily figure out any variation thereof, or make equivalent substitution to some of the technical features thereof. However, these modifications, variations, or substitutions do not make the essence of the corresponding technical solutions depart from the spirit and scope of the technical solutions of the embodiments of the present disclosure, and shall fall within the scope of protection of the present disclosure. Therefore, the scope of protection of the present disclosure shall be subject to the scope of protection of the claims.

1. A search result display method, comprising:
obtaining, in response to a search request, a preview resource of a target video that matches the search request, wherein the preview resource comprises video preview information of the target video and structured information for answering the search request, the structured information is information extracted from the target video, and the structured information comprises at least prerequisite information, answer information, and timestamp information that respectively corresponds to the prerequisite information and the answer information in the target video; and
displaying the video preview information on a search result page, and displaying the structured information at an associated position of the video preview information.

2. The search result display method according to claim 1, wherein the displaying the video preview information on a search result page, and displaying the structured information at an associated position of the video preview information comprises:
displaying the video preview information in a first area of the search result page, successively displaying the timestamp information in a second area adjacent to the first area, and displaying, at a corresponding position of each piece of timestamp information, prerequisite information and answer information corresponding to the piece of timestamp information.

3. The search result display method according to claim 2, wherein at least one piece of prerequisite information is comprised, and each piece of prerequisite information corresponds to at least one piece of answer information; and the displaying the video preview information on a search result page, and displaying the structured information at an associated position of the video preview information comprises:
displaying the video preview information in the first area of the search result page, successively displaying, in the second area adjacent to the first area, each piece of prerequisite information and timestamp information corresponding to the piece of prerequisite information in the structured information, and displaying, under each piece of prerequisite information, at least one piece of corresponding answer information and timestamp information corresponding to each piece of answer information.

4. The search result display method according to claim 2, wherein the displaying the video preview information on a search result page, and displaying the structured information at an associated position of the video preview information comprises:
when the structured information comprises one piece of prerequisite information and a plurality of pieces of answer information, displaying the video preview information in the first area of the search result page, displaying, in the second area adjacent to the first area, the prerequisite information and timestamp information corresponding to the prerequisite information, and successively displaying, under the prerequisite information, the plurality of pieces of answer information and timestamp information respectively corresponding to the pieces of answer information in a sequence of timestamps corresponding to the plurality of pieces of answer information; or
when the structured information comprises a plurality of pieces of prerequisite information and each piece of prerequisite information corresponds to a plurality of pieces of answer information, displaying the video preview information in the first area of the search result page, successively displaying, in the second area adjacent to the first area, the pieces of prerequisite information and timestamp information corresponding to the pieces of prerequisite information in a sequence of timestamps of the pieces of prerequisite information, and successively displaying, under each piece of prerequisite information, pieces of answer information corresponding to the piece of prerequisite information and timestamp information respectively corresponding to the pieces of answer information in a sequence of timestamps of the pieces of answer information.

5. The search result display method according to claim 1, wherein the displaying the structured information at an associated position of the video preview information comprises:
determining, based on an answer type of answer information corresponding to each piece of prerequisite information, a display form of each piece of prerequisite information and the corresponding answer information; and
displaying each piece of prerequisite information and the corresponding answer information at the associated position of the video preview information based on the display form.

6. The search result display method according to claim 5, wherein the answer type of the answer information corresponding to each piece of prerequisite information is determined in the following manner:
if the target video comprises a plurality of pieces of step information corresponding to the search request, determining that the answer type is a first answer type, wherein each piece of answer information corresponds to one piece of step information; or
if the target video comprises a plurality of parts of answer information corresponding to the search request, and each part of answer information comprises a plurality of parts of sub-answer information, determining that the answer type is a second answer type.

7. The search result display method according to claim 6, wherein in response to the answer type being the first answer type, the displaying each piece of prerequisite information and the corresponding answer information at the associated position of the video preview information based on the display form comprises:
displaying, at the associated position of the video preview information, timestamp information of the prerequisite information and each part of answer information in a sequence of timestamps corresponding to the prerequisite information and the corresponding answer information.

8. The search result display method according to claim 6, wherein in response to the answer type corresponding to the answer information being the second answer type, the displaying each piece of prerequisite information and the corresponding answer information at the associated position of the video preview information based on the display form comprises:
displaying each part of answer information at the associated position of the video preview information; and
displaying, in response to a trigger operation for any piece of answer information, a plurality of pieces of sub-answer information corresponding to the piece of answer information.

9. The search result display method according to claim 1, wherein the structured information further comprises recommendation information associated with the search request; and
the displaying the structured information at an associated position of the video preview information comprises:
displaying, at a corresponding position of each piece of timestamp information, prerequisite information and answer information corresponding to the piece of timestamp information, and displaying, under at least one piece of answer information, the recommendation information associated with the search request and the answer information.

10. The search result display method according to claim 1, further comprising:
playing, in response to a trigger operation for the prerequisite information or any part of answer information in the structured information, the target video from a timestamp position corresponding to the prerequisite information or the part of answer information.

11. The search result display method according to claim 1, wherein in response to a plurality of target videos being comprised, the method further comprises:
determining degrees of association between structured information of the plurality of target videos and the search request, and sorting the plurality of target videos based on the degrees of association; and
the displaying the video preview information, and displaying the structured information at an associated position of the video preview information comprises:
successively displaying video preview information of the plurality of target videos based on a result of sorting the target videos, and displaying the structured information at associated positions of the video preview information.

12. (canceled)

13. A computer device, comprising: a processor and a memory, wherein the memory stores machine-readable instructions executable by the processor, the processor is configured to execute the machine-readable instructions stored in the memory, and when the machine-readable instructions are executed by the processor, the processor performs a search result display method, and the search result display method comprises:
obtaining, in response to a search request, a preview resource of a target video that matches the search request, wherein the preview resource comprises video preview information of the target video and structured information for answering the search request, the structured information is information extracted from the target video, and the structured information comprises at least prerequisite information, answer information, and timestamp information that respectively corresponds to the prerequisite information and the answer information in the target video; and
displaying the video preview information on a search result page, and displaying the structured information at an associated position of the video preview information.

14. A non-transitory computer-readable storage medium, wherein the non-transitory computer-readable storage medium stores a computer program, and when the computer program is run by a computer device, the computer device performs a search result display method, and the search result display method comprises:
obtaining, in response to a search request, a preview resource of a target video that matches the search request, wherein the preview resource comprises video preview information of the target video and structured information for answering the search request, the structured information is information extracted from the target video, and the structured information comprises at least prerequisite information, answer information, and timestamp information that respectively corresponds to the prerequisite information and the answer information in the target video; and
displaying the video preview information on a search result page, and displaying the structured information at an associated position of the video preview information.

15. The computer device according to claim 13, wherein the displaying the video preview information on a search result page, and displaying the structured information at an associated position of the video preview information comprises:
displaying the video preview information in a first area of the search result page, successively displaying the timestamp information in a second area adjacent to the first area, and displaying, at a corresponding position of each piece of timestamp information, prerequisite information and answer information corresponding to the piece of timestamp information.

16. The computer device according to claim 15, wherein at least one piece of prerequisite information is comprised, and each piece of prerequisite information corresponds to at least one piece of answer information; and the displaying the video preview information on a search result page, and displaying the structured information at an associated position of the video preview information comprises:
displaying the video preview information in the first area of the search result page, successively displaying, in the second area adjacent to the first area, each piece of prerequisite information and timestamp information corresponding to the piece of prerequisite information in the structured information, and displaying, under each piece of prerequisite information, at least one piece of corresponding answer information and timestamp information corresponding to each piece of answer information.

17. The computer device according to claim 15, wherein the displaying the video preview information on a search result page, and displaying the structured information at an associated position of the video preview information comprises:
when the structured information comprises one piece of prerequisite information and a plurality of pieces of answer information, displaying the video preview information in the first area of the search result page, displaying, in the second area adjacent to the first area, the prerequisite information and timestamp information corresponding to the prerequisite information, and successively displaying, under the prerequisite information, the plurality of pieces of answer information and timestamp information respectively corresponding to the pieces of answer information in a sequence of timestamps corresponding to the plurality of pieces of answer information; or
when the structured information comprises a plurality of pieces of prerequisite information and each piece of prerequisite information corresponds to a plurality of pieces of answer information, displaying the video preview information in the first area of the search result page, successively displaying, in the second area adjacent to the first area, the pieces of prerequisite information and timestamp information corresponding to the pieces of prerequisite information in a sequence of timestamps of the pieces of prerequisite information, and successively displaying, under each piece of prerequisite information, pieces of answer information corresponding to the piece of prerequisite information and timestamp information respectively corresponding to the pieces of answer information in a sequence of timestamps of the pieces of answer information.

18. The computer device according to claim 13, wherein the displaying the structured information at an associated position of the video preview information comprises:
determining, based on an answer type of answer information corresponding to each piece of prerequisite information, a display form of each piece of prerequisite information and the corresponding answer information; and
displaying each piece of prerequisite information and the corresponding answer information at the associated position of the video preview information based on the display form.

19. The computer device according to claim 18, wherein the answer type of the answer information corresponding to each piece of prerequisite information is determined in the following manner:
if the target video comprises a plurality of pieces of step information corresponding to the search request, determining that the answer type is a first answer type, wherein each piece of answer information corresponds to one piece of step information; or
if the target video comprises a plurality of parts of answer information corresponding to the search request, and each part of answer information comprises a plurality of parts of sub-answer information, determining that the answer type is a second answer type.

20. The computer device according to claim 19, wherein in response to the answer type being the first answer type, the displaying each piece of prerequisite information and the corresponding answer information at the associated position of the video preview information based on the display form comprises:
displaying, at the associated position of the video preview information, timestamp information of the prerequisite information and each part of answer information in a sequence of timestamps corresponding to the prerequisite information and the corresponding answer information.

21. The computer device according to claim 19, wherein in response to the answer type corresponding to the answer information being the second answer type, the displaying each piece of prerequisite information and the corresponding answer information at the associated position of the video preview information based on the display form comprises:
displaying each part of answer information at the associated position of the video preview information; and
displaying, in response to a trigger operation for any piece of answer information, a plurality of pieces of sub-answer information corresponding to the piece of answer information.
